(19) United States
(12) Patent Application Publication
(10) Pub. No.: US 2025/0139448 A1
(43) Pub. Date: May 1, 2025

(54) Personalized Model Training for Users Using Data Labels

(71) Applicant: Google LLC, Mountain View, CA (US)

(72) Inventor: Keun Soo Yim, San Jose, CA (US)

(21) Appl. No.: 18/499,621

(22) Filed: Nov. 1, 2023

(51) Int. Cl. G06N 3/09; G06N 3/0475

(52) U.S. Cl. CPC G06N 3/09; G06N 3/0475

(57) ABSTRACT

Systems and methods for generating a machine-learned model are disclosed herein. The method can include receiving, by a computing system comprising one or more processors, one or more data items, the one or more data items being associated with usage of a user device by a user and inferring, by the one or more processors, one or more data labels based on the one or more data items, the data labels being indicative of the usage of the user device by the user. The method can also include generating, by the one or more processors, a personalized model using the one or more data labels and a base model.

### FIELD

The present disclosure relates generally to generating machine-learned models. More particularly, the present disclosure relates to generation of personalized machine-learned models for a user or a group of users based on data labels.

### BACKGROUND

Large, generic machine-learned models can be trained to perform a wide variety of tasks within a particular discipline, such as classification, generation, or other functions of machine-learned models. This is made possible due to advances in deep learning and accessibility to a wide variety of large datasets.

However, individual users normally do not require this level of versatility from models all at once. Instead, users often require models that are specialized to particular requests, such as classifying only a few, but frequently encountered, data items or generating similar data items.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for generating a machine-learned model. The method can include receiving, by a computing system comprising one or more processors, one or more data items, the one or more data items being associated with usage of a user device by a user and inferring, by the one or more processors, one or more data labels based on the one or more data items, the data labels being indicative of the usage of the user device by the user. The method can also include generating, by the one or more processors, a personalized model using the one or more data labels and a base model.

Another example aspect of the present disclosure is directed to a computing system. The computing system can include a processor and a non-transitory, computer-readable medium comprising instructions that, when executed by the processor, cause the processor to perform operations. The operations can include receiving one or more data items, the one or more data items being associated with usage of a user device by a user, and inferring one or more data labels based on the one or more data items, the data labels being indicative of the usage of the user device by the user. The operations can also include generating a personalized model using the one or more data labels and a base model.

Another example aspect of the present disclosure is directed to a non-transitory, computer-readable medium comprising instructions that, when executed by a processor, cause the processor to perform operations. The operations can include receiving one or more data items, the one or more data items being associated with usage of a user device by a user, and inferring one or more data labels based on the one or more data items, the data labels being indicative of the usage of the user device by the user. The operations can also include generating a personalized model using the one or more data labels and a base model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example model personalization system according to example embodiments of the present disclosure.

FIG. 1B depicts a block diagram of an example model personalization system according to example embodiments of the present disclosure.

FIG. 2 depicts a block diagram of an example model modification system according to example embodiments of the present disclosure.

FIG. 3 depicts a flow chart diagram of an example method for generating a personalized model according to example embodiments of the present disclosure.

FIG. 4A depicts a block diagram of an example computing system for generating a personalized model according to example embodiments of the present disclosure.

FIG. 4B depicts a block diagram of an example computing device for generating a personalized model according to example embodiments of the present disclosure.

FIG. 4C depicts a block diagram of an example computing device for generating a personalized model according to example embodiments of the present disclosure.

Reference numerals that are repeated across plural figures are intended to identify the same features in various implementations.

### DETAILED DESCRIPTION

### Overview

Generally, the present disclosure is directed to generating personalized machine-learned models. More particularly, the present disclosure relates to techniques for automatically generating personalized machine-learned models for a user or a group of users based on data labels automatically inferred from user data associated with the user or the group of users.

More particularly, user requirements for models tend to be more personal and require more focused and less general knowledge than current, generic large models. A solution for end users can be the construction of personalized models dedicated to more personalized needs of each user or group of users. These smaller, personalized models do not require as much memory, bandwidth, or processing power, and therefore can be deployed in edge computing cases or in other scenarios where computing resources may be limited.

Naively, to obtain a personalized model, a general model can be retrained upon request. Doing so, however, is not scalable from a service provider's point of view. Typically, the computation cost for retraining a model for every individual user scales linearly with the number of requests. Training latency can also degrade the user experience.

Therefore, according to an aspect of the present disclosure, a computing system can leverage train-one-for-all model personalization approaches. Generally, in train-once-for-all approaches, personalizing a model first includes training a large, generic base model. A base model can be a machine-learned model that is capable of a range of general tasks across various disciplines. The base model can be trained a vast quantity of data from the various disciplines using a wide range of training techniques, such as self-supervised learning, semi-supervised learning, unsupervised learning, and the like.

The base model can then be personalized “on the fly” for a user or a cluster of users based on the requirements and/or preferences of the user or cluster of users. To personalize the base model, a predictor network can be used. The predictor network can receive descriptive labels of data and, based on the descriptive labels, generate or modify weights and/or parameters of the base model to be “personalized” for the needs of the user or cluster of users based as illustrated by the descriptive labels of data. Other personalization techniques, such as condensing base models in the base model into smaller networks based on the descriptive data labels, can also be performed by the predictor network.

According to an aspect of the present disclosure, the descriptive data labels can be automatically obtained in a variety of ways. Users using devices, such as smartphones, laptop computers, tablet computers, desktop computers, and other computing devices are constantly generating usage data. For example, a user may take and save photos of various objects, people, and animals. In some embodiments, the software application that enables the user to take and/or store the photos can utilize a machine-learned model to generate descriptive labels associated with the taken and stored photos, such as a textual label indicating “a dog jumping to catch a frisbee.” In other embodiments, the photos can be provided from the software application to a storage location. For example, the storage location can be a cloud-based remote server or can be a centralized data aggregation location that remains within the user device. When the photos are saved to the storage location, a machine-learned model can be used to generate the descriptive data labels.

To provide an example, a software application can provide its application contents or other data to a platform storage that is present on the user device. These contents can be labeled using the application's own machine learning backend. This backend could potentially employ libraries like MLKit or equivalent for the labeling process. Additionally or alternatively, in instances where the submitted application contents or other usage data are not labeled by the backend for the application's own use cases, these contents can be labeled by a background service that operates on the platform storage. For example, the background service can scan all the data ingested into the platform storage and provide appropriate labels. Such a service can also employ MLKit or an equivalent library for this labeling process.

Thus, a platform storage service (e.g., either provided by a cloud server or performed on the user's device) can store diverse application contents which significantly contribute to the efficient operation of the proposed personalization mechanism. This storage can be embodied in a variety of formats, accommodating different types of data. One of the possible storage formats that can be utilized is the use of a NoSQL database, such as the AppSearch solution offered within the Android Operating System. This type of storage can be particularly advantageous when dealing with application contents that do not adhere to a strict schema or require flexibility in data modeling.

Additionally or alternatively, the platform storage can utilize a system of file storage. This can be a local file system or a BlobStore, wherein the data is stored in binary large objects (blobs). This type of storage is particularly effective when dealing with large files, such as images or multimedia files, which are often included in application content.

As yet another example, SQL databases, such as SQLite3, can also be employed within the platform storage service. The use of SQL databases provides a structured approach to data storage, where data is stored in tables and accessed using structured query language (SQL). This type of storage can be advantageous when dealing with application contents that have a defined schema, allowing for efficient data management and retrieval.

After the descriptive data labels are generated, the data labels can be applied to the base model by the predictor network. To apply the data labels to the base model, the predictor network can obtain a vector representation of the data labels, which can represent the various data labels in the base model weight space. By modeling the data labels as a vector representation, the personalized model can quickly be obtained from the base model without any additional training, but rather by inference. This helps to bypass the bottleneck of training cost and enables the generation of a personalized model to be more similar to a real-time application program interface (“API”) instead of having to train a personalized model on a user device, which can incur significant performance costs on the user device.

In some implementations, the personalized model can be deployed in various applications such as image recognition and other use cases to enhance user experience and machine learning accuracy. For example, the personalized model can be used in an image recognition application on a user's device, such as a smartphone or a tablet. This application can leverage the personalized model to accurately identify objects, people, animals, and other elements in the user's photos. The application can then provide the user with pertinent information or options based on the recognized elements, thus enriching the user's interaction with the application.

Moreover, the model can be used to recognize and understand not only the broader categories of elements but also more detailed sub-categories within those broader categories. For example, the model can distinguish between different breeds of dogs or types of cars. This capability to recognize detailed sub-categories can further enhance the user experience by providing more specific and relevant information or options to the user.

While the previously outlined embodiments primarily focus on image recognition, the scope of the present disclosure is not restricted to this specific application. For instance, the process of labeling application contents and the subsequent generation of personalized models can equally be employed for services such as voice recognition, natural language processing, predictive text generation, recommendation systems, and even complex tasks like autonomous navigation. In each of these cases, the concept of utilizing user-specific or group-specific data labels to personalize the base model remains consistent. The model's knowledge of the user's personal entities and preferences can be leveraged to provide customized and relevant outputs to the user.

By utilizing personalized models, a user can obtain more accurate and personalized results from machine learning-based applications and services, thereby improving their overall experience. This can also lead to an improvement in machine learning accuracy, as the personalized model is more attuned to the user's personal entities and preferences.

The use of fully-personalized models, therefore, presents a significant potential for the enhancement of user experience and the advancement of machine learning accuracy in various applications and use cases.

In some embodiments, in order to save more memory and/or generate more robust “personalized” models, a personalized model can be generated for a cluster of users. Many users will generate usage data that is similar: pictures of similar objects, animals or people; similar search terms in software applications; similar typed words in messages; and other examples. Thus, it can be advantageous to utilize federated learning and/or federated analytics techniques to generate a personal model for a cluster of users that have similar data labels generated for their usage data.

To generate these personalized models for clusters of users, data labels can be aggregated across users that share similar data labels. This technique can be grounded in the observation that many users share similar sets of personal entities, thereby making it advantageous to group users into clusters based on these shared similarities. For example, two users can be determined to share similar sets of data labels based on a percentage difference between the sets of data labels being less than a threshold percentage, vector representations of each set of data labels having a similarity score above a threshold percentage, and other various comparisons to determine the similarity between the sets of data labels. For example, this process of comparing and evaluating the similarity can be facilitated by an algorithmic mechanism that operates on the backend.

Once two or more sets of data labels are determined to be similar enough to be in a shared cluster, each set of data labels can be used by the predictor network to generate a personalized model that is then shared between each user in the cluster. This enables “personalized” models to be generated for a whole cluster of users instead of each user individually, which saves computing resources such as bandwidth, processing capability, and memory, while providing each user in the cluster with a more robust model that has been trained on their own usage data plus the similar, but not identical, usage data of other users in the cluster.

Some example implementations can operate to anonymize the collection of descriptive labels of data. By simply collecting data labels from user usage data (e.g., as opposed to centrally collecting the raw user usage data itself), user privacy can be improved. To obtain a personalized model with improved user privacy, the vector representation of the data labels can be provided as the only identifying information for the user of the user device to the personalization system. After the model is personalized using the vector representation of the data labels, the personalized model can be provided back to the user device without needing any personal identification information for the user. This enables the model to be personalized to the user's actual data usage without needing any form of personal identification linking the user to their usage data. This can be especially advantageous when aggregating data for clusters of users, as only the vector representations of each user in the cluster are required for personalizing a model, and no identifying data for users is necessary. Furthermore, during the transmission of data labels to the server, various techniques such as data anonymization or encryption can be employed to ensure that the transmitted data cannot be linked back to the individual user.

Another aspect of privacy-sensitive operation involves the aggregation of data labels for clusters of users. By grouping users based on similarities in their data labels, the system can create more generalized, cluster-based models, rather than individual user-based models. This process inherently anonymizes the data, as the resultant models reflect the group as a whole, rather than any individual user.

Thus, aspects of the present invention enable personalized models to be generated for users or clusters of users without the need to constantly train new models for each individual user. This reduces the amount of computing resources (e.g., processing capability, memory, network bandwidth, and the like) required to generate and maintain machine-learned models for users. Additionally, aspects of the present invention provide more enhanced, personalized models to users or clusters of users in fewer training cycles, as the use of the data labels allows models to be personalized without needing to fully train or retrain a model.

With reference now to the Figures, example embodiments of the present disclosure will be discussed in further detail.

### Example Model Arrangements

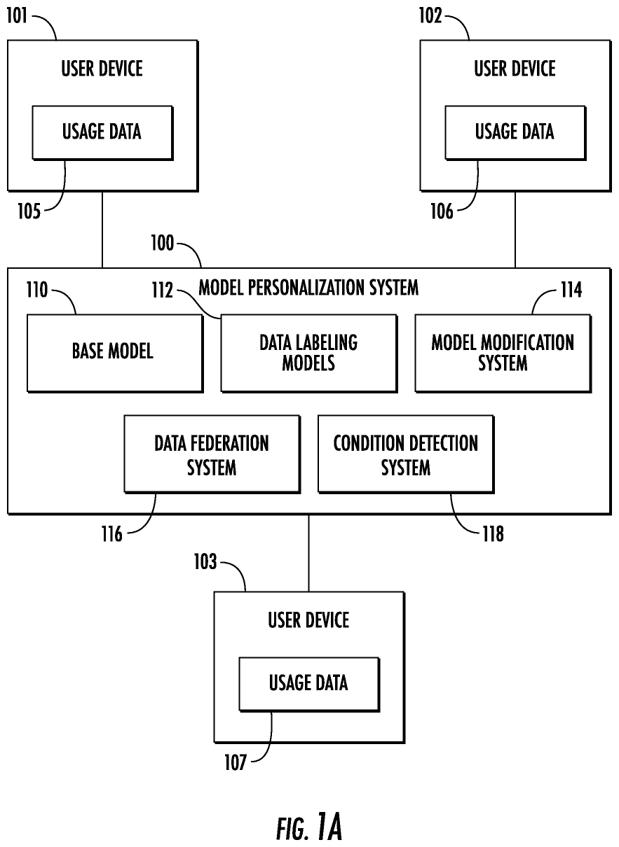

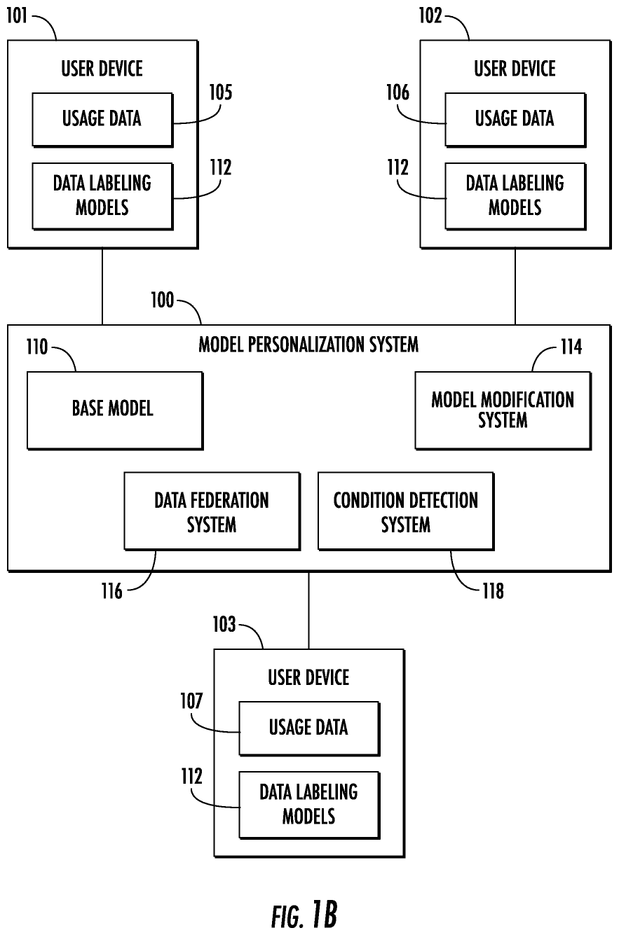

FIG. 1 depicts a block diagram of an example model personalization system 100 according to example embodiments of the present disclosure.

The model personalization system 100 can be, in some embodiments, a server computing system in communication with one or more user devices 101, 102, and 103, collectively referred to herein as “user devices.” The user devices can be smartphones, laptop computers, desktop computers, smart wearables, tablet computers, and other computing devices. Generally, each of the user devices can include one or more processors and one or more memories.

Usage data can be stored within the one or more memories of each of the user devices, such as usage data 105, 106, and 107 (collectively referred to herein as “usage data”) for user devices 101, 102, and 103, respectively.

The usage data indicates various aspects of users interacting with each of the user devices. In one example, the usage data can include photographic images taken using a photography software application and stored in a memory of the respective user device. In another example, the usage data can include one or more search queries that each include one or more search terms. In further examples, the usage data can include information typed as text in messaging software applications, time of use data of various software applications, and other data indicative of a user's use of a respective user device.

In some embodiments, instead of being stored on the user devices, the usage data can be stored remotely on a server computing system, such as in a cloud-based computing system.

In some embodiments, the usage data may be pre-labeled usage data. Data labeling is the process of processing raw data, such as images, text files, videos, and other data, and adding one or more meaningful and informative labels to the raw data to provide context for the data. For example, in an image, a data label can indicate objects in the image, such as a dog jumping to catch a frisbee, a person standing up in a room, an item sitting on a table, and the like.

The model personalization system 100 can include a base model 110, one or more data labeling models 112, a model modification system 114, a data federation system 116, and a condition detection system 118.

The base model 110 can be a general, pre-trained model trained to perform a specific task, such as classification or generation. In some embodiments, the model personalization system 100 can include two or more different base models, each of which is trained to perform a different task. The base model 110 can be any suitable type of machine-learned model.

In some embodiments, the base model 110 can include one or more weights or parameters learned during initial training. These weights and parameters are used by layers of the base model 110 to process input and obtain a final output.

The one or more data labeling models 112 can include various machine-learned models for taking in the usage data as input and generating one or more data labels for the usage data. For example, in an image, a data label can indicate objects in the image, such as a dog jumping to catch a frisbee, a person standing up in a room, an item sitting on a table, and the like. The one or more data labeling models 112 can receive input data, such as an image, and output one or more data labels describing the input data, such as a textual label that reads “a banana sitting on a table” for an image of a banana sitting on a table. Each model of the one or more data labeling models 112 can be directed to labeling different types of usage data, such as a model for labeling images, a model for labeling videos, a model for labeling text files, a model for labeling other types of files, and similar models.

In some embodiments, the one or more data labeling models 112 can be implemented wholly as a server-side service (e.g., present only in the memory of the model personalization system 100), and the usage data can all be received at the model personalization system 100 as unlabeled data. In other embodiments, the one or more data labeling models 112 can be wholly or partially implemented on the user devices, and can be used by the user devices to generate data labels for the usage data before sending the usage data (and any generated labels) to the model personalization system 100. An example of this embodiment can be found in FIG. 1B.

The model modification system 114 can enable the model personalization system 100 to use generated data labels associated with usage data from a particular user device to generate a personalized model.

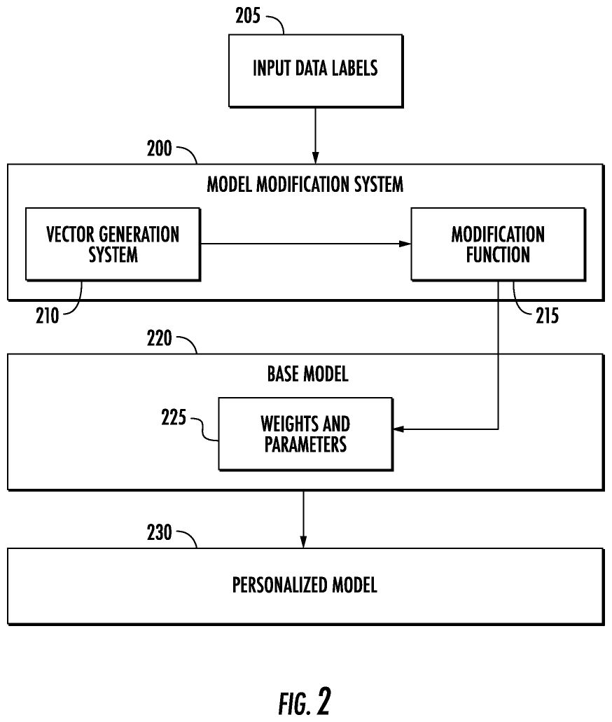

FIG. 2 depicts a block diagram of an example model modification system 200 according to example embodiments of the present disclosure.

The model modification system 200 can receive, as input, input data labels 205, which are one or more data labels associated with usage data from one or more user devices. The input data labels 205 are provided to a vector generation system 210. The vector generation system 210 can generate a vector, or a structured representation of data in numerical form. In some embodiments, the vector generation system 210 can use a machine-learned predictor network to generate the vector representation of the input data labels. The vector generation system 210 can extract features from the data labels by, for example, mapping text in a label to its vector form, or vector representation, of the data labels. The vector representation can then be provided to a modification function 215.

The modification function 215 can make changes to weights and parameters 225 based on the vector representation of the data labels. For example, the modification function 215 can prioritize a first weight over a second weight, can disregard a weight or parameter in the base model 220, can select one or more layers to use from the base model 220, and the like.

In some embodiments, the modification function 215 can selectively combine two or more base models by, for example, taking a union representation of weights and parameters 225 of the base models.

The modification function 215 can therefore make changes to the weights and parameters 225 of base model 220 to generate a personalized model 230. In some embodiments, the modification function 215 can disregard unneeded weights and parameters from the weights and parameters 225, and the resulting personalized model 230 can be a smaller, less computationally intensive model that can be ideal for deployment to an edge computing device, such as a smartphone or laptop.

In some embodiments, this vector representation of the input data labels 205 can share an embedding space with the embedding space of weights and parameters 225 of base model 220.

Returning now to FIG. 1, the model personalization system 100 can include the data federation system 116. Data federation system 116 can enable the model personalization system 100 to use federated training techniques to generate a personalized model. The data federation system 116 can receive usage data from various user devices, such as from user device 101, 102, and/or 103. In some embodiments, the data federation system 116 can receive the usage data as vector representations of the usage data.

Data federation system 116 can determine whether or not to aggregate the usage data and/or the vector representations of the usage data. For example, the data federation system 116 can determine if two sets of usage data share similar sets of data labels, or determine a similarity or similarity score of the two sets of usage data. If the two sets of usage data are determined to be similar enough, the data federation system 116 can aggregate the two sets of usage data. For example, the data federation system 116 can determine a percentage of similarity between the two sets of usage data. If the percentage of similarity between the two sets of usage data is above a threshold, the two sets of usage data are determined to be similar, and can be aggregated into one vector representation of the two sets of usage data. This vector representation of the two sets of usage data can then be used to generate a personalized model.

The data federation system 116 can perform this type of data aggregation for clusters of users, or groups of users numbering in the hundreds, thousands, or even millions, based on the similarities in the sets of usage data associated with each of the users. By performing data aggregation to generate personalized models for clusters of users, data federation system 116 can reduce the number of individual models that need to be generated, saving computing resources, while also creating more robust models by capturing a large number of users in one vector representation of usage data.

Additionally, the use of data federation can ensure data privacy for the users. Users do not have to provide any identifying information to access different clusters of personalized models or provide identifying information to receive a personalized model. Instead, the user is tied only to a vector representation of the usage data of their respective user device. Based on a similarity of the vector representation of the usage data of their respective user device, the user can be provided a personalized model from the model personalization system 100 individually or from a cluster without having to provide identifying information to the model personalization 100.

In some embodiments, to determine one or more clusters and/or to determine a similarity between an existing cluster and a newly received set of usage data, the data federation system 116 can use techniques such as k-means clustering or k nearest neighbor clustering.

Condition detection system 118 can detect conditions that can cause a personalized model to be updated. For example, condition detection system 118 can detect when a set period of time has elapsed (one day, one week, one month, etc.). When this condition is detected, condition detection system 118 can provide a notification to the model personalization system 100 to request new usage data from a user device. The user device can, in some embodiments, provide usage data (which may have changed since the last update) to the model personalization system 100 along with any pre-existing personalized models currently stored on the user device to the model personalization system 100. The model personalization system 100 can then generate a new personalized model based on the usage data, the existing personalized model, and/or the base model 110. In other embodiments, the model personalization system 100 can simply generate a new personalized model based only on the usage data and the base model 110, and may not take into account any existing personalized models from the user device.

Other conditions that can be detected by the condition detection system 118 can include detecting a number of new data labels being collected at the user device, detecting one or more changes one or more data labels, and a detecting an idle state of the user device.

It is to be understood that some or all of the functionality of the model personalization system 100 can be implemented partially or wholly on the user devices or on one or more other computing systems.

### Example Methods

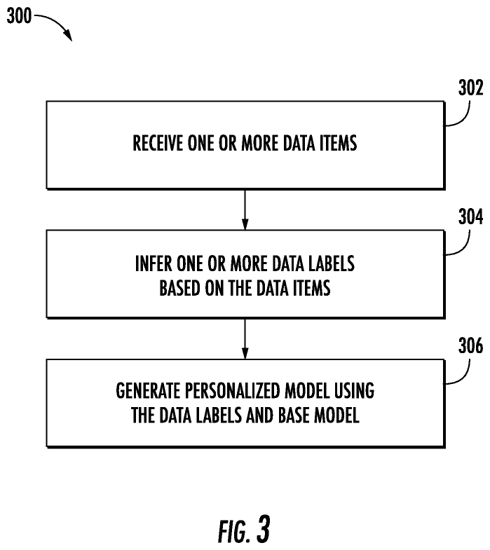

FIG. 3 depicts a flow chart diagram of an example method 300 to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can receive one or more data items, the one or more data items being associated with usage of a user device by a user.

At 304, the computing system can infer one or more data labels based on the one or more data items, the data labels being indicative of the usage of the user device by the user. To infer the one or more data labels, the computing system can, for example, receive data labels for data items that have been labeled at the user device, or can utilize one or more data labeling models to automatically generate labels for the data items without requiring any user input for labels.

In some embodiments, inferring the one or more data labels can include processing the one or more data items using a machine-learned labeling model and receiving the one or more data labels as an output of the machine-learned labeling model. In some embodiments, the machine-learned labeling model can be contained within a memory of the user device. In other embodiments, the machine-learned labeling model can be contained within a memory of a server computing system.

In some embodiments, inferring the one or more data labels can include generating a vector representation of the one or more data labels, where the vector representation of the one or more data labels can share a vector space with a model weight vector of the base model. In some embodiments, the vector representation of the one or more data labels can be generated using a machine-learned predictor network.

At 306, the computing system can generate a personalized model using the one or more data labels and a base model. In some embodiments, to generate the personalized model, the computing system can generate one or more modifications to at least one of a weight, a layer, or a parameter of the base model based on the vector representation of the one or more data labels and can then apply the one or more modifications to the base model to generate the personalized model.

In some embodiments, generating the personalized model can include aggregating a plurality of sets of data labels from a plurality of user devices, wherein the one or more data labels are included as one set of data labels in the plurality of sets of data labels. A vector representation of the plurality of sets of data labels can then be generated and the personalized model can be generated using the vector representation of the plurality of sets of data labels.

In some embodiments, aggregating the plurality of sets of data labels can include determining a similarity between one or more data labels and a second set of data labels of the plurality of sets data label and adding the one or more data labels to the plurality of sets of data labels based on the similarity being above a threshold.

In some embodiments, the method 300 can also include providing the personalized model to the user device. In some embodiments, the personalized model is a smaller model than the base model, and is therefore more optimized for operating on the user device, which can include less computing resources than larger, server-based computing systems.

In some embodiments, the method 300 can also include determining an update for the personalized model based on an occurrence of one or more conditions. The one or more conditions can include determining that a predetermined amount of time has elapsed, a number of new data labels have been collected at the user device, one or more changes to the one or more data labels have been detected, an idle state of the user device has been detected, or other conditions.

In some embodiments, when the condition is detected, the method 300 can also include receiving the personalized model from the user device and receiving a second set of one or more data labels. An updated personalized model can then be generated based on the personalized model and the second set of one or more data labels.

### Example Devices and Systems

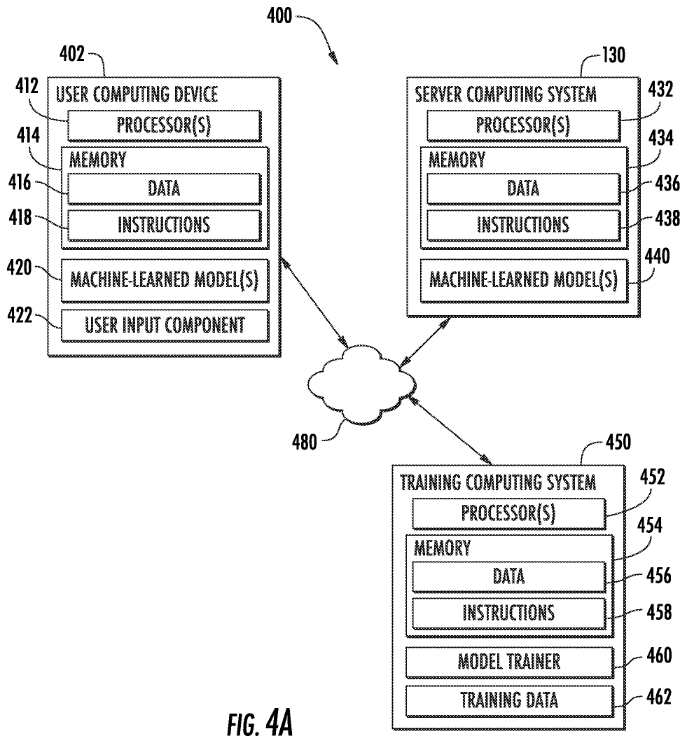

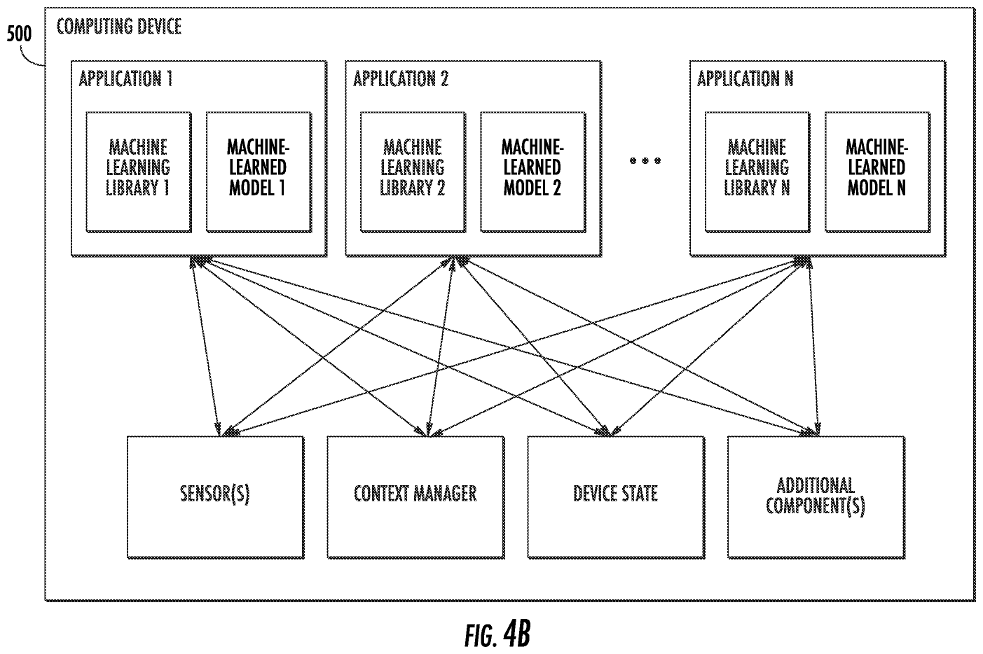

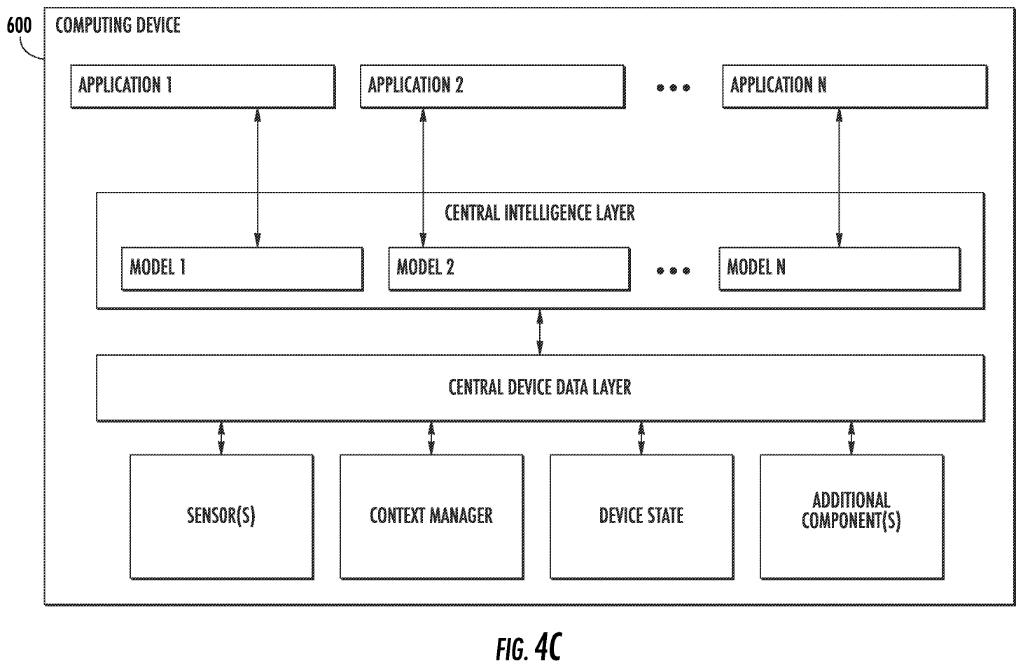

FIG. 4A depicts a block diagram of an example computing system 400 that performs personalized model generation according to example embodiments of the present disclosure. The system 400 includes a user computing device 402, a server computing system 430, and a training computing system 450 that are communicatively coupled over a network 480.

The user computing device 402 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 402 includes one or more processors 412 and a memory 414. The one or more processors 412 can be any suitable processing device (e.g., a processor core, a microprocessor, an ASIC, an FPGA, a controller, a microcontroller, etc.) and can be one processor or a plurality of processors that are operatively connected. The memory 414 can include one or more non-transitory computer-readable storage media, such as RAM, ROM, EEPROM, EPROM, flash memory devices, magnetic disks, etc., and combinations thereof. The memory 414 can store data 416 and instructions 418 which are executed by the processor 412 to cause the user computing device 402 to perform operations.

In some implementations, the user computing device 402 can store or include one or more models 420. For example, the models 420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example models 420 are discussed with reference to FIGS. 1 and 2.

In some implementations, the one or more models 420 can be received from the server computing system 430 over network 480, stored in the user computing device memory 414, and then used or otherwise implemented by the one or more processors 412. In some implementations, the user computing device 402 can implement multiple parallel instances of a single model 420 (e.g., to perform parallel personalized model generation).

Additionally or alternatively, one or more models 440 can be included in or otherwise stored and implemented by the server computing system 430 that communicates with the user computing device 402 according to a client-server relationship. For example, the models 440 can be implemented by the server computing system 440 as a portion of a web service (e.g., a model generation service). Thus, one or more models 420 can be stored and implemented at the user computing device 402 and/or one or more models 440 can be stored and implemented at the server computing system 430.

The user computing device 402 can also include one or more user input components 422 that receives user input. For example, the user input component 422 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage media, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices. In instances in which the server computing system 430 includes plural server computing devices, such server computing devices can operate according to sequential computing architectures, parallel computing architectures, or some combination thereof.

As described above, the server computing system 430 can store or otherwise include one or more models 440. For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 440 are discussed with reference to FIGS. 1 and 2.

The user computing device 402 and/or the server computing system 430 can train the models 420 and/or 440 via interaction with the training computing system 450 that is communicatively coupled over the network 480. The training computing system 450 can be separate from the server computing system 430 or can be a portion of the server computing system 430.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage media, such as RAM, ROM, EEPROM, EPROM, flash memory devices, magnetic disks, etc., and combinations thereof. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that trains the machine-learned models 420 and/or 440 stored at the user computing device 402 and/or the server computing system 430 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained.

In particular, the model trainer 460 can train the models 420 and/or 440 based on a set of training data 462.

In some implementations, if the user has provided consent, the training examples can be provided by the user computing device 402. Thus, in such implementations, the model 420 provided to the user computing device 402 can be trained by the training computing system 450 on user-specific data received from the user computing device 402. In some instances, this process can be referred to as personalizing the model.

The model trainer 460 includes computer logic utilized to provide desired functionality. The model trainer 460 can be implemented in hardware, firmware, and/or software controlling a general purpose processor. For example, in some implementations, the model trainer 460 includes program files stored on a storage device, loaded into a memory and executed by one or more processors. In other implementations, the model trainer 460 includes one or more sets of computer-executable instructions that are stored in a tangible computer-readable storage medium such as RAM, hard disk, or optical or magnetic media.

The network 480 can be any type of communications network, such as a local area network (e.g., intranet), wide area network (e.g., Internet), or some combination thereof and can include any number of wired or wireless links. In general, communication over the network 480 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 4A illustrates one example computing system that can be used to implement the present disclosure. Other computing systems can be used as well. For example, in some implementations, the user computing device 402 can include the model trainer 460 and the training dataset 462. In such implementations, the models 420 can be both trained and used locally at the user computing device 402. In some of such implementations, the user computing device 402 can implement the model trainer 460 to personalize the models 420 based on user-specific data.

FIG. 4B depicts a block diagram of an example computing device 500 that performs according to example embodiments of the present disclosure. The computing device 500 can be a user computing device or a server computing device.

The computing device 500 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 600 that performs according to example embodiments of the present disclosure. The computing device 600 can be a user computing device or a server computing device.

The computing device 600 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 600.

The central intelligence layer can communicate with a central device data layer. The central device data layer can be a centralized repository of data for the computing device 600. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for generating a machine-learned model, the method comprising:
receiving, by a computing system comprising one or more processors, one or more data items, the one or more data items being associated with usage of a user device by a user;
inferring, by the one or more processors, one or more data labels based on the one or more data items, the data labels being indicative of the usage of the user device by the user, wherein the one or more data labels are inferred using a predictor network to generate a vector representation of the one or more data labels in a base model weight space; and
generating, by the one or more processors, a personalized machine-learned model for the user in real time using the one or more data labels and a base model, wherein the personalized model is generated by modifying a weight or parameter of the base model based on the vector representation of the one or more data labels without requiring additional training of the personalized model.

2. The computer-implemented method of claim 1, wherein inferring the one or more data labels comprises:
processing, by the one or more processors, the one or more data items using a machine-learned labeling model; and
receiving, by the one or more processors, the one or more data labels as an output of the machine-learned labeling model.

3. The computer-implemented method of claim 2, wherein the machine-learned labeling model is contained within a memory of the user device.

4. The computer-implemented method of claim 2, wherein the machine-learned labeling model is contained within a memory of a server computing system.

5. (canceled)

6. (canceled)

7. The computer-implemented method of claim 1, wherein generating the personalized model using the one or more data labels and the base model comprises:
applying, by the one or more processors, the one or more modifications to the base model to generate the personalized model.

8. The computer-implemented method of claim 1, wherein generating the personalized model comprises:
aggregating, by the one or more processors, a plurality of sets of data labels from a plurality of user devices, wherein the one or more data labels are included as one set of data labels in the plurality of sets of data labels;
generating, by the one or more processors, a vector representation of the plurality of sets of data labels; and
generating, by the one or more processors, the personalized model using the vector representation of the plurality of sets of data labels.

9. The computer-implemented method of claim 8, wherein aggregating the plurality of sets of data labels comprises:
determining, by the one or more processors, a similarity between one or more data labels and a second set of data labels of the plurality of sets data labels; and
adding, by the one or more processors, the one or more data labels to the plurality of sets of data labels based on the similarity being above a threshold.

10. The computer-implemented method of claim 1, further comprising:
providing, by the one or more processors, the personalized model to the user device.

11. The computer-implemented method of claim 10, further comprising:
determining, by the one or more processors, an update for the personalized model based on an occurrence of one or more conditions;
receiving, by the one or more processors, the personalized model from the user device;
receiving, by the one or more processors, a second set of one or more data labels; and
generating, by the one or more processors, an updated personalized model based on the personalized model and the second set of one or more data labels.

12. The-computer implemented method of claim 11, wherein the one or more conditions include at least one condition from a group of conditions consisting of a predetermined time elapsing, a number of new data labels being collected at the user device, a detection of one or more changes to the one or more data labels, and a detection of an idle state of the user device.

13. A computing system, comprising:
a processor; and
a non-transitory, computer-readable medium comprising instructions that, when executed by the processor, cause the processor to perform operations, the operations comprising:
receiving one or more data items, the one or more data items being associated with usage of a user device by a user;
inferring one or more data labels based on the one or more data items, the data labels being indicative of the usage of the user device by the user, wherein the one or more data labels are inferred using a predictor network to generate a vector representation of the one or more data labels in a base model weight space; and
generating a personalized machine-learned model for the user in real time using the one or more data labels and a base model, wherein the personalized model is generated by modifying a weight or parameter of the base model based on the vector representation of the one or more data labels without requiring additional training of the personalized model

14. (canceled)

15. (canceled)

16. The computing system of claim 13, wherein generating the personalized model using the one or more data labels and the base model comprises:
applying, by the one or more processors, the one or more modifications to the base model to generate the personalized model.

17. The computing system of claim 13, wherein generating the personalized model comprises:
aggregating a plurality of sets of data labels from a plurality of user devices, wherein the one or more data labels are included as one set of data labels in the plurality of sets of data labels;
generating a vector representation of the plurality of sets of data labels; and
generating the personalized model using the vector representation of the plurality of sets of data labels.

18. The computing system of claim 17, wherein aggregating the plurality of sets of data labels comprises:
determining a similarity between one or more data labels and a second set of data labels of the plurality of sets data labels; and
adding the one or more data labels to the plurality of sets of data labels based on the similarity being above a threshold.

19. A non-transitory, computer-readable medium comprising instructions that, when executed by a processor, cause the processor to perform operations, the operations comprising:
receiving one or more data items, the one or more data items being associated with usage of a user device by a user;
inferring one or more data labels based on the one or more data items, the data labels being indicative of the usage of the user device by the user, wherein the one or more data labels are inferred using a predictor network to generate a vector representation of the one or more data labels in a base model weight space; and
generating a personalized machine-learned model for the user in real time using the one or more data labels and a base model, wherein the personalized model is generated by modifying a weight or parameter of the base model based on the vector representation of the one or more data labels without requiring additional training of the personalized model

20. (canceled)
